(19) United States
(12) Patent Application Publication
(10) Pub. No.: US 2018/0271217 A1
(43) Pub. Date: Sep. 27, 2018

(54) POLYMERIC TREATMENT FOR TEXTILE MATERIAL, AND MATERIALS FORMED THEREBY

(71) Applicant: New Balance Athletics, Inc., Boston, MA (US)

(72) Inventors: Mark Somers, Brighton, MA (US); Joseph M. McLellan, Quincy, MA (US); Xinhua Li, Newton, MA (US); Patrick Reust, Somerville, MA (US); Austin Arroco, Medford, MA (US); Adam Lee Thielsen, Amesbury, MA (US); Anthony DiMari, Boston, MA (US); Sean B. Murphy, North Andover, MA (US)

(21) Appl. No.: 15/809,594

(22) Filed: Nov. 10, 2017

Related U.S. Application Data
(60) Provisional application No. 62/420,955, filed on Nov. 11, 2016.

(51) Int. Cl. A43B 23/02; B05D 3/00; A43B 1/14; A43B 5/00

(52) U.S. Cl. CPC A43B 23/0265; B05D 3/007; A43B 23/0215; A43B 5/00; A43B 1/14

(57) ABSTRACT

The invention relates to a polymeric treatment for a textile component. An exemplary method of treating a textile element for incorporation into at least a portion of an upper of an article of footwear includes applying a thermoplastic polymer to a textile element having at least one first region and at least one second region, selectively activating the thermoplastic polymer in the at least one first region to modify at least one structural property of the at least one first region, and leaving the thermoplastic polymer in the at least one second region of the textile element unactivated, wherein the at least one modified structural property of the at least one first region differs from at least one structural property of the at least one second region.

### CROSS-REFERENCE TO RELATED APPLICATIONS

This application claims priority to and the benefit of U.S. Provisional Patent Application Ser. No. 62/420,955, filed Nov. 11, 2016, the disclosure of which is incorporated herein by reference in its entirety.

### FIELD OF THE INVENTION

The present invention relates generally to the field of textiles and, more particularly, to a polymeric treatment for a textile mesh component that allows for the selective modification of a structural property of the textile to create selective and customizable support and elasticity in the textile. The textile may be beneficial in creating selective regions of support and elasticity in a component of a shoe upper.

### BACKGROUND OF THE INVENTION

The incorporation of textiles having different structural properties in different regions of the textile can be important in a number of industries and products. For example, footwear, and more particularly athletic footwear, includes uppers with different stretch and support characteristics required in different regions of the upper. Traditionally, uppers for athletic footwear are formed from multiple different material portions, with those portions being placed in different regions of the upper of the footwear, and/or layered over each other in certain regions of the footwear, to provide the desired structural and performance characteristics for the shoe. Forming footwear from these multiple material portions can, however, be both labor intensive and expensive, while also potentially adding weight and other negative structural limitations to the structure and performance capabilities of the footwear.

An exemplary prior art method of forming a shoe upper is described in U.S. Pat. No. 9,573,331 to McDowell. This method describes the infusion of thermoplastic polyurethane (“TPU”) into a spacer mesh which is thereafter heat-molded to form a three-dimensionally shaped shoe portion. However, by infusing the entire mesh with material and forming the full, infused, material into a shoe component, the method provides for only a simple, uniform, material having TPU spread evenly throughout, which can add considerable excess weight to the material without allowing for the formation of a unitary part having complex and targeted structural characteristics.

### SUMMARY OF THE INVENTION

Given the complexity and cost associated with the formation of textile elements having complex and varied structural properties through traditional methods, it is desirable to provide improved methods and treatments for standard textiles that allow for the provision of complex structural and/or decorative features on a single textile without the need for the addition of multiple layers or for the incorporation of additional materials into the textile during initial manufacturing. Accordingly, the materials and methods described herein provide innovative methods for creating unique structural and aesthetic features on and in textile elements for use, for example, in the formation of uppers for articles of footwear.

A first aspect of the invention includes a method of treating a textile element for incorporation into at least a portion of an upper of an article of footwear. In some embodiments, the method includes the steps of applying a thermoplastic polymer to a textile element having at least one first region and at least one second region and selectively activating the thermoplastic polymer in the at least one first region to modify at least one structural property of the at least one first region. The method further includes leaving the thermoplastic polymer in the at least one second region of the textile element unactivated, wherein the at least one modified structural property of the at least one first region differs from at least one structural property of the at least one second region. The textile element can include, or consist essentially of, at least one of a knit material, a woven material, a non-woven material, a skrim, a polyester, a nylon, a spandex, a natural fiber, cotton, and/or wool.

In one embodiment, applying the thermoplastic polymer to the textile element includes dipping the textile element in the thermoplastic polymer. In another embodiment applying the thermoplastic polymer to the textile element includes coating the thermoplastic polymer onto the textile element through at least one of spray coating, rolling, and painting. Applying the thermoplastic polymer to the textile element may further include controlling the extent to which the thermoplastic polymer penetrates into the textile element. In one embodiment applying the thermoplastic polymer to the textile element includes the steps of providing a first solution having a continuous phase solution, dispersing a discontinuous phase in the first solution to form a stabilized mixture, the discontinuous phase including the thermoplastic polymer, applying the stabilized mixture to a textile element, and treating the textile element to remove the continuous phase solution from the textile element while leaving the thermoplastic polymer in place on the textile element.

Selectively activating the thermoplastic polymer in the at least one first region can include exposing the at least one first region to at least one of heat, pressure, light, HF waves, UV waves, and a chemical reactant and, for example, can include, or consist essentially of, heat pressing the at least one first region. In one embodiment, selectively activating the thermoplastic polymer in the at least one first region includes heat pressing the first region, where the textile element is further heated in an oven to set the thermoplastic polymer in the second region without heat pressing.

In one embodiment, the method further includes removing the unactivated thermoplastic polymer in the at least one second region after selectively activating the thermoplastic polymer in the at least one first region. Removing the unactivated thermoplastic polymer may include, or consist essentially of, washing the textile element in at least one aqueous solution.

The at least one structural property of the first region and the second region can be at least one of a modulus of elasticity, a stiffness, a flexibility, a hardness, a strength, a tear strength, a tensile strength, a permeability, a breathability, a bond strength, and/or an abrasion resistance of the textile element. The first region may include, or consist essentially of, a plurality of discrete elongate portions of the upper, where activation of the thermoplastic polymer in the first region provides structural support to the upper. The first region may include, or consist essentially of, an array of separate, discrete islands of activated material and/or a web of interconnecting portions of activated material.

The at least one thermoplastic polymer may, in certain embodiments, include, or consist essentially of, at least one of thermoplastic polyurethane, thermoplastic copolyesters, thermoplastic styrene acrylic copolymers, thermoplastic rubbers, synthetic rubber, elastomeric copolymers, crosslinkable elastomers, polyester block copolymers, polyolefins, and/or engineered polyethelenes.

Another aspect of the invention includes a method of forming an article of footwear. In some embodiments, the method includes the steps of providing an upper for an article of footwear, the upper including at least one textile element; providing a sole element; and attaching the sole element to the upper. Forming the at least one textile element for the upper can include applying a thermoplastic polymer to the at least one textile element having at least one first region and at least one second region, selectively activating the thermoplastic polymer in the at least one first region to modify at least one structural property of the at least one first region, and leaving the thermoplastic polymer in at least one second region unactivated, wherein the at least one structural property of the at least one first region differs from at least one structural property of the at least one second region. In one embodiment, forming the at least one textile element further includes removing the unactivated thermoplastic polymer in the at least one second region after selectively activating the thermoplastic polymer in the at least one first region. In one embodiment, the at least one first region can include, or consist essentially of, at least one of an array of separate, discrete islands of activated material, a plurality of discrete elongate elements of activated material, and/or an interconnected web of activated material.

Another aspect of the invention includes a method of treating a textile component, the method including the steps of: (i) preparing a first solution including a continuous phase solution, (ii) dispersing a discontinuous phase in the first solution to form a stabilized mixture, the discontinuous phase including one or more thermoplastic polymer, (iii) applying the stabilized mixture to a textile element, (iv) treating the textile element to remove the continuous phase solution from the textile element while leaving the thermoplastic polymer in place on the textile element, and (v) selectively activating the thermoplastic polymer in at least one first region of the textile element to modify at least one structural property of the first region.

In one embodiment the continuous phase solution includes an aqueous solution (e.g., water). The first solution can also include one or more surface active agent (i.e., surfactant) such as, but not limited to, a surfactant having a hydrophile-lipophile balance (HLB) number of between about 5 and about 60. The thermoplastic polymer can include, or consist essentially of, at least one of thermoplastic polyurethane, thermoplastic copolyesters (e.g., Hytrel® as sold by E. I. du Pont de Nemours and Company, of Wilmington, Del., U.S.A.), thermoplastic styrene acrylic copolymers, thermoplastic rubbers, synthetic rubber, elastomeric copolymers, crosslinkable elastomers, polyester block copolymers, polyolefins, or engineered polyethelenes. The synthetic rubber can include, or consist essentially of, a block co-polymer such as styrene butadiene rubber (SBR), styrene butadiene styrene (SBS), styrene-isoprene-styrene (SIS), styrene ethylene butylene styrene (SEBS), or ethylene propylene diene monomer (EPDM). Further exemplary materials include those provided by Sartomer Americas, of 502 Thomas Jones Way, Exton, Pa. 19341, U.S.A., and styrenic block copolymers (SBC) consisting of polystyrene blocks and rubber blocks as sold under the name Kraton™ by Kraton Polmers LLC, of 2419 OH-618, Belpre, Ohio 45714, U.S.A.

The thermoplastic polymer can be dispersed in a second solution, which can include, or consist essentially of, one or more solvent and an aqueous solution (e.g., water). The solvent may, for example, include, or consist substantially of, Dichloromethane (DCM), Dimethylformamide (DM F), Tetrahydrofuran (THF), Acetone, and/or Methyl Ethyl Ketone (MEK). In one embodiment the discontinuous phase can be emulsified droplets of thermoplastic polymer or a colloidal dispersion of thermoplastic polymer. The discontinuous phase can be mixed into and dispersed within the first solution using one or more mixing element such as, but not limited to, an ultrasonic mixer (i.e., a device providing ultrasonification such as an ultrasonic horn), a high shear mixer, a high speed blender, a high pressure homogenizer, a colloid mill, a high shear disperser, an ultrasonic disruptor, a membrane homogenizer and/or any other appropriate type of mixing system to produce a stabilized dispersion of thermoplastic polymer within the aqueous solution. In one embodiment, forming the stabilized mixture includes mixing the mixture (e.g., by applying a stir-bar to the mixture in proximity to a venting system) to allow all, substantially all, or a portion of, the solvent to evaporate from the mixture.

After forming the stabilized mixture it can be applied to a textile. The textile may be a knit material, a woven material, a non-woven material, a skrim, or any other appropriate fabric material. The textile can be made of materials such as, but not limited to, a polyester, a nylon, a spandex or other elastic material, a natural fiber (e.g., cotton or wool), a blend thereof, or any other appropriate material for use in the construction of footwear uppers. The stabilized mixture can be applied to the textile element through methods such as, but not limited to, dipping the textile element in the stabilized mixture, spray coating the textile with the mixture, or painting the mixture onto the textile with a roller, brush, or other appropriate coating mechanism. In various embodiments the stabilized mixture can be applied in such a manner as to ensure that the mixture penetrates into and through the textile (or a portion thereof). Alternatively, the mixture can be applied in a manner that limits the mixture to coating only a surface of the textile with little or no penetration into the interior of the textile material.

After applying the stabilized mixture, the treated textile can by dried, either naturally or by applying heat, air flow, etc., to the textile to evaporate the continuous phase solution from the textile element while leaving the thermoplastic polymer in place on the textile. In one embodiment, the drying step results in the entire continuous phase solution, or substantially all of the continuous phase solution, being removed from the textile, while in other embodiments a portion of the continuous phase solution (e.g., the surfactant, or a portion thereof) can be left on the textile after drying.

After drying, the thermoplastic polymer on the textile can be selectively activated to modify one or more properties of the textile. In one embodiment, the thermoplastic polymer is activated in one or more select regions of the textile, with the thermoplastic polymer remaining unactivated in other regions. In an alternative embodiment the thermoplastic polymer on the entire textile can be activated. In one embodiment, the thermoplastic polymer is activated through heat pressing the first region (either in an open environment or in a heat press mold). After activating selected regions through heat pressing or, in certain embodiments, in place of activation through heat pressing, the textile can be heated in an oven, or otherwise treated (e.g., through exposure to a light—e.g., laser light—, HF waves, UV waves, and/or a chemical reactant) to set any thermoplastic polymer that hasn't already been heat pressed onto and/or into the textile permanently onto/into the textile.

For example, in one embodiment of the invention, the textile includes one or more first regions and one or more second regions, with the first regions being heat pressed to activate and permanently set the thermoplastic polymer to the textile and the textile thereafter being heated in an oven to set the thermoplastic polymer in the second region without heat pressing. In an alternative embodiment, after heat pressing selected first regions to activate and set the thermoplastic polymer in those regions, the textile can be treated (e.g., washed, laundered, etc.) in the second, non-heat pressed, regions to remove the thermoplastic polymer entirely, or substantially entirely, from those second regions. This treatment can include, or consist essentially of, washing the textile in an aqueous solution and, optionally, a detergent.

Activating the thermoplastic polymer in the selected regions changes one or more structural property of the textile in that region. Exemplary structural properties that can be changed include, but are not limited to a modulus of elasticity, a stiffness, a flexibility, a hardness, a strength, a tear strength, a tensile strength, a permeability, a breathability, a bond strength, and an abrasion resistance of the textile element. In certain embodiments the extent to which a property is changed can depend on the activation mechanism used and the extent to which the activation mechanism is applied.

In one embodiment, the textile element can be used to form at least a portion of an upper for an article of footwear. In this case, the one or more first regions, where the thermoplastic polymer is activated through heat pressing, can form portions of the upper where reduced or limited elasticity of the textile is beneficial, such as in areas of the upper that are exposed to high stress during athletic activity. In contrast, areas of the textile in which the thermoplastic polymer are not heat pressed can correspond with areas of the upper where greater elasticity is beneficial, such as areas of the upper in which greater flexibility and/or comfort are beneficial during athletic activity. In one embodiment, the first region comprises a plurality of discrete elongate portions of the upper surrounded at least in part by at least one second region, with the first region providing structural support to at least a portion of the upper.

Another aspect of the invention relates to a textile component and, for example, a textile component formed from the methods described herein. The textile component includes at least one first region and at least one second region. The textile component is treated with a stabilized mixture including a continuous phase solution and a discontinuous phase including at least one thermoplastic polymer. The continuous phase solution is removed from the textile element after treating the textile component with the stabilized mixture. The thermoplastic polymer is activated in the at least one first region, and a structural property of the first region with the activated thermoplastic polymer differs from a structural property of the second region. Another aspect of the invention includes an article of footwear including a sole and an upper, with the upper including at least one textile element, and with the textile element having at least one first region and at least one second region as described herein.

Yet another aspect of the invention includes a textile finish formulation and a textile treated by such textile finish formulation. The textile finish formulation includes an aqueous continuous phase and a discontinuous phase including at least one of emulsified droplets or a colloidal dispersion of thermoplastic polymer, wherein the discontinuous phase is stabilized in the continuous phase by a surface active agent. The continuous phase is adapted to be removed upon application of the textile finish formulation to a textile while leaving the thermoplastic polymer deposited throughout the textile, and the thermoplastic polymer is adapted to modify at least one structural property of the textile upon activation by application of one or more external stimuli. The structural property can include a modulus of elasticity of the textile, and the modulus of elasticity is increased by at least a factor of two in an activated region of the textile relative to an unactivated region of the textile.

In one embodiment, the discontinuous phase is 0.5% to 50% by weight of the total textile finish formulation, and preferably 1% to 25% by weight of the total textile finish formulation. The discontinuous phase may be present as droplets or particles with an average diameter of between 0.001 μm and 100 μm, or between 0.005 μm and 50 μm, or preferably between 0.01 μm and 1 μm as determined by optical or electron microscopy. The thermoplastic polymer in the discontinuous phase may include, or consist essentially of, materials such as, but not limited to, thermoplastic polyurethane, synthetic rubber, and/or an elastomeric copolyester. The synthetic rubber may be a block co-polymer such as, but not limited to, styrene-butadiene rubber. The discontinuous phase may be dispersed with an surface active agent that has an hydrophilic lipophilic balance (HLB) value between about 5 and about 60.

In one embodiment, upon application to a textile and removal of the continuous phase to yield a finished textile the appearance of the finished textile is substantially unchanged from the appearance of the textile prior to exposure to the textile finish formulation. In one embodiment, upon application to a textile and removal of the continuous phase to yield a finished textile the modulus of the finished textile is substantially unchanged from the modulus of the textile prior to exposure to the textile finish formulation. The thermoplastic polymer that is present in unactivated portions of a finished textile can be substantially removed from the finished textile by washing, laundering, etc.

Another aspect of the invention includes a method of manufacturing a finished textile. The method includes the steps of (i) applying a textile finish formulation to a textile to achieve a wet textile basis weight that is between about 0.5 times and about 10 times the dry basis weight of an untreated textile, and (ii) drying the wet textile to remove the continuous phase of the textile finish formulation and to deposit the thermoplastic polymer from the discontinuous phase throughout the volume of the textile resulting in a finished textile with a 1% to 100% increase in basis weight relative to the dry untreated textile. The method can further include mechanically removing a portion of the textile finish formulation until the wet textile basis weight is between about 1.1 times and about 5 times the basis weight of the dry untreated textile prior to drying. In one embodiment, drying the wet textile comprises applying heat to the wet textile to remove the continuous phase of the textile finish formulation. The method can also include activating the finished textile through the application of a combination of heat and pressure to selective areas of the finished textile sufficient to activate the thermoplastic polymer by causing it to reflow and bond adjacent fibers and yarns in the activated regions of the textile yielding at least a two times increase in modulus of the activated regions of the finished textile relative to the modulus of the unactivated regions of the finished textile.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described.

FIG. 1 is a schematic side view of a method of mixing an aqueous solution and a thermoplastic polymer to form a stabilized mixture, in accordance with some embodiments of the invention;

FIG. 2A is a schematic perspective view of a textile being treated with a stabilized mixture by dip coating, in accordance with some embodiments of the invention;

FIG. 2B is a schematic perspective view of a textile being treated with a stabilized mixture by spray coating, in accordance with some embodiments of the invention;

FIG. 3 is a flow chart of an exemplary method of treating a textile component, in accordance with some embodiments of the invention;

FIG. 4A is a side view of an exemplary article of footwear incorporating a treated textile component, in accordance with some embodiments of the invention;

FIG. 4B is a side view of another exemplary article of footwear incorporating a treated textile component, in accordance with some embodiments of the invention;

FIG. 4C is a side view of another exemplary article of footwear incorporating a treated textile component, in accordance with some embodiments of the invention;

FIG. 4D is a side view of another exemplary article of footwear incorporating a treated textile component, in accordance with some embodiments of the invention;

FIG. 5A is a perspective view of another exemplary article of footwear incorporating a treated textile component, in accordance with some embodiments of the invention;

FIG. 5B is a top plan view of the article of footwear of FIG. 5A.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### DETAILED DESCRIPTION

The invention described herein relates to textiles having improved performance and/or aesthetic characteristics, and methods of manufacturing such textiles. The invention allows for the treatment of standard textiles (e.g., standard knit, woven, or non-woven textile meshes) without the need to incorporate additional materials into the textiles during the formation of those textiles, and without the need to stitch or bond other materials to the textile to produce the desired structural and/or aesthetic properties. The methods described herein therefore provide a method by which standard untreated, off-the-shelf, textiles can be customized to produce finished textile elements having a variety of complex structural properties, thereby reducing material costs and simplifying the manufacturing process. The textiles created hereby can be utilized in any number of products and industries, including, but not limited to, footwear (and, for example, athletic footwear), apparel, sporting goods (e.g., lacrosse stick nets, protective sports gear, etc.) and other goods requiring complex textile constructions. In addition to uses within the athletics and fashion industries such structures may, for example, be useful in the automotive, aerospace, and consumer goods industries.

More particularly, the methods and systems described herein provide a textile finish formulation that can be applied to a textile and which can be selectively activated in/on the textile to change one or more property of the textile in the activated area(s) without substantially changing the properties of the textile in the unactivated region(s), and without changing the aesthetics of the textile in the unactivated region(s). As a result, a single textile can be modified to provide a variety of complex structural properties without the need for additional materials or complicated processing.

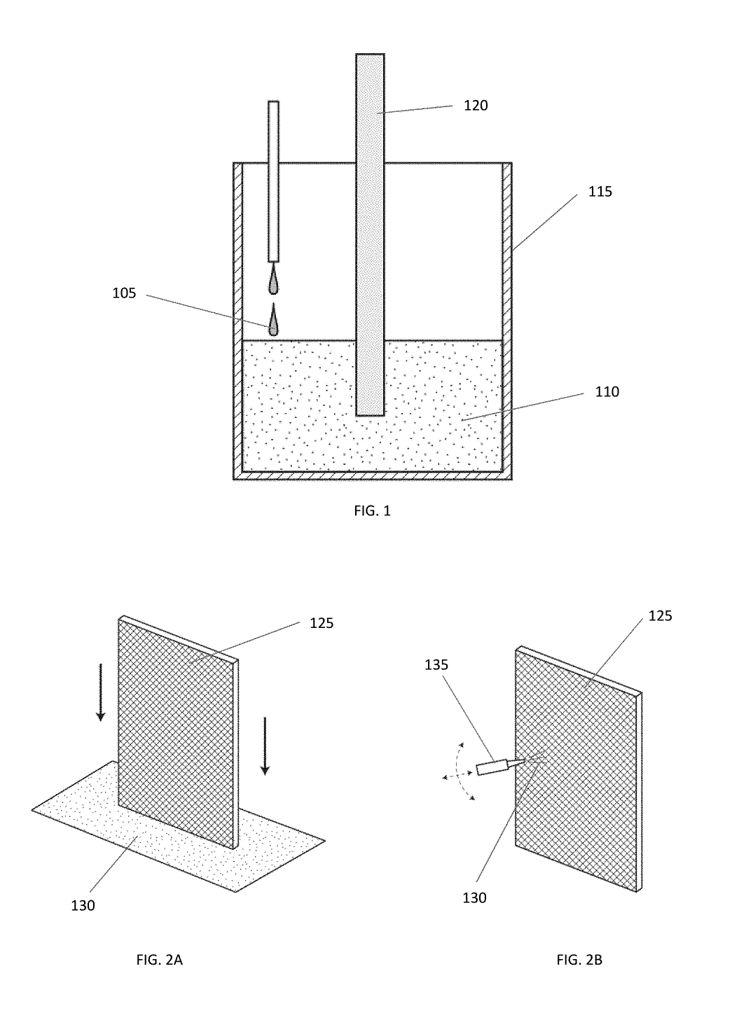

An exemplary method of forming a textile finish formulation and treating a textile is described below and shown in FIGS. 1 through 3. The method includes dissolving a polymer in a mixture of solvent and an aqueous solution (e.g., water) to create a discontinuous phase mixture. The polymer may, for example, be thermoplastic polyurethane (TPU) in, for example, ground, pellet, or film form. The solvent can, for example, be dimethylformamide (DMF). Alternative solvents include, but are not limited to, dichloromethane (DCM), dimethylformamide (DMF), tetrahydrofuran (THF), acetone, and/or methyl ethyl ketone (MEK).

The mixture of polymer with the solvent and water 105 is then mixed with a continuous phase solution 110 of water and one or more surfactant in a container 115. In various embodiments the mixing method can include, but is not limited to, ultrasonication (e.g., using an ultrasonic horn 120), high shear mixing, or mixing through the use of a high speed blender, a high pressure homogenizer, a colloid mill, a high shear disperser, an ultrasonic disruptor, and/or a membrane homogenizer. The surfactant, or surfactants, can be any surfactants known in the art and, in one embodiment, is a surfactant preferably chosen to match the polymer and preferably optimized for an hydrophile-lipophile balance (HLB) number of generally between 5 and 60, or about 5 and about 60. In other examples the surfactant, or surfactants, can be chosen to match the polymer and preferably optimized for an hydrophile-lipophile balance (HLB) number of generally between 5 and 40, or about 5 and about 40. Exemplary surfactants for use with the methods and treatments described herein are distributed by Sigma-Aldrich Corporation, whose headquarters is at 3050 Spruce Street, St. Louis, Mo. 63103, U.S.A. In one embodiment, the surfactant is sodium dodecyl sulfate/sodium lauryl sulfate (SDS/SLS).

Once this mixture is sufficiently mixed to become a stabilized dispersion it is positioned on a mixing device, e.g., a mixer with stir-bar under venting system (e.g., a venting hood), to allow the solvent that the polymer was dissolved in to evaporate from the mixture, thereby leaving the polymer dispersed in the aqueous solution. This dispersion mixture can then be applied to a textile, for example via painting, rolling, spray coating or dip coating. An exemplary method of dip coating a textile 125 in a bath of the dispersion mixture 130 is shown in FIG. 2A, while a method of spraying the dispersion mixture 130 onto the textile 125 using one or more sprayer 135 is shown in FIG. 2B. The textile can thereafter be allowed to dry such that the aqueous solution evaporates and leaves the polymer coated onto/into the textile.

In one embodiment thermoplastic materials can be dispersed into an aqueous emulsion without the use of an initial solvent-borne mixture. For example, melt kneading and extrusion processes can be used to form a melt blended product using techniques and technology such as, but not limited to, single and multi-screw extruders or using Bluewave™ Technology from Dow Global Technologies, LLC, of Washington Street, 1790 Building, Midland, Mich. 48674, U.S.A. These processes can be used to shear molten thermoplastics at elevated temperatures and pressures, effectively creating aqueous dispersions with a discontinuous phase of thermoplastic particles.

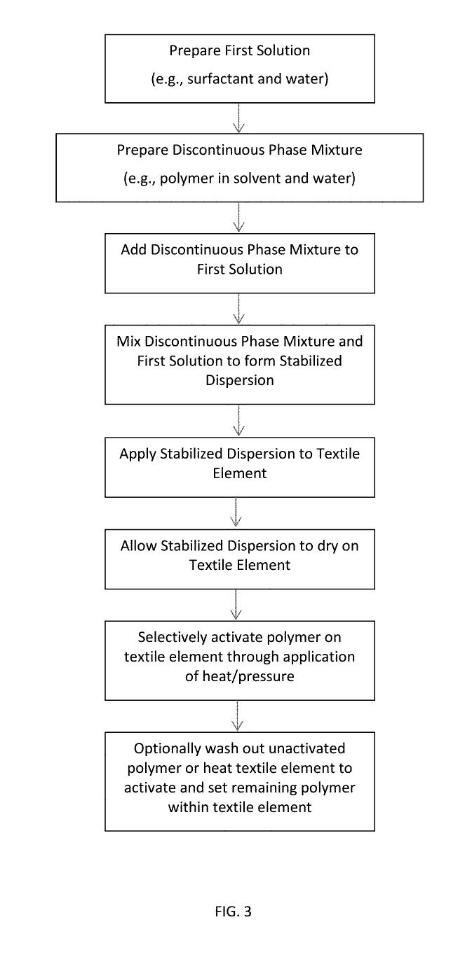

Thereafter, heat/pressure (e.g., by a heat press) can be selectively applied to selected areas of the textile where a property change of the textile is desired. After heat pressing the selected areas, the remaining coating on the non-heat pressed regions can be washed out or can be permanently affixed/set to the coating through heating in an oven. A flow chart showing this illustrative method is shown in FIG. 3. In one embodiment, the entire textile 125 is treated with the stabilized dispersion mixture 130, with the unactivated portions of the polymer either washed from the material 125 or set on the material 125 after the portions requiring activation are activated. In an alternative embodiment, only selected portions of the textile 125 are treated with the stabilized mixture 130, with other portions of the textile 125 remaining free of the stabilized mixture 130. For example, in certain embodiments, one or more masking elements can be applied to the textile 125 to prevent masked portions of the textile 125 from being treated.

In various embodiments one, or a combination of, physical properties of the textile can be modified through the methods described herein. These physical properties can include, but are not limited to, a modulus of elasticity, a stiffness, a flexibility, a hardness, a strength, a tear strength, a tensile strength, a permeability, a breathability, a bond strength, and an abrasion resistance of the textile element. For example, applying heat and pressure to selected regions of the textile can change the modulus or elasticity of the textile, and can, for example, increase the modulus of elasticity of the textile by up to about 200% (2×), or up to about 500% (5×), or up to about 1500% (15×), or potentially more with polymer loading levels as low as 25% by weight. In one embodiment, increases of up to about 3000% (30×) or higher are achievable through optimal selection of materials and appropriately concentrated loading levels. In an alternative embodiment, appropriate selection of materials, chemistry, and treatment parameters may allow for a reduction of the modulus of elasticity upon activation. As a result, the finished textile can have one or more regions (where the polymer was activated on the textile) having a first elasticity and one or more second regions (where the polymer wasn't activated on the textile) having a second elasticity greater than that in the first regions. Similarly, other structural properties of the textile can be modified to different degrees through activation of the polymer in only selected regions.

The method of coating the stabilized mixture containing the polymer can be important in controlling the change in physical properties caused by the activation of the polymer. For example, dip coating the textile for a short time may only allow the stabilized mixture (and the polymer dispersed therein) to penetrate the textile to a limited extent, while dip coating the textile for a longer period may allow the stabilized mixture (and the polymer dispersed therein) to penetrate completely, or substantially completely, through the textile. Controlling the extent to which the mixture penetrates the textile controls the amount of polymer coated on and embedded in the textile, which can therefore control the effect of the polymer on the textile upon activation (with, in one embodiment, more polymer creating a greater change in structural property). Similarly, varying the time and strength of a spray coating application can also change the amount of polymer in/on the textile to change the extent to which the polymer changes the one or more physical property upon activation.

Changing the specific parameters of the activation method can also be important in controlling the change in physical properties caused by the activation of the polymer. For example, controlling the temperature and/or pressure of the heat press and/or the time for which the heat press is applied can, in certain embodiments, control the extent to which the polymer changes the one or more physical property upon activation. In this example, increasing the temperature of the heat press, increasing the pressure, and/or increasing the time of application can increase the activation of the polymer and thereby increase the change in the physical property being modified. In certain embodiments the upper limit of the temperature applied to activate the polymer may be the thermal load at which the fibers within the textile begin to plastically deform and produce structural and mechanical changes in the base textile itself as opposed to only altering the deposited polymer materials. As a result, the changes in structural properties created by the activation of the polymer can be controlled to create different changes in different region, such that the finished article potentially has a broad range of structural features (e.g., a broad range of modulus of elasticity values) extending across it. This allows for the creation of complex and truly customized performance characteristics in a finished textile.

In certain embodiments of the invention, the thermoplastic polymer on/in the base textile material can be activated through any appropriate thermal, chemical, optical, and/or mechanical activation mechanism. In one embodiment, the thermoplastic polymer can be activated through the application of a laser light to the thermoplastic polymer treated textile material through the use of a laser-based system such as a selective laser sintering (“SLS”) or stereolithography (“SLA”) system.

For example, a textile material can be positioned within the tank of liquid photo-polymerizing resin of a stereolithography system (e.g., a thermosetting polymer with a light-activated material incorporated therein) with the resin penetrating the textile material, after which a laser or digital light processing element of the system can be directed onto the textile material to selectively activate portions of the liquid photo-polymerizing resin on/in the textile material. The textile material can thereafter be removed from the tank and the unactivated resin in the non-targeted portion(s) of the textile element can be washed away or otherwise removed. Alternatively, a textile material can be placed within a powder bed of a selective laser sintering system with thermoplastic powder spread over and/or within the textile material. The SLS system laser can then be used to activate the powder in selected portions of the textile material, after which the textile material can be removed from the powder bed and the unactivated powder in the non-targeted portions of the textile material removed through washing, vacuuming, blowing, or any other appropriate method.

In alternative embodiments, a thermoplastic polymer can be applied to the textile material as a liquid or powder in any appropriate manner, after which the polymer can be activated by one or more laser or digital light processing element.

In one alternative embodiment, a textile may not be needed, with the stabilized mixture instead being sprayed directly into a mold or other receptacle for the solution and thereby selectively heat pressed or otherwise activated to create a sheet of material formed entirely of the thermoplastic polymer. This sheet of thermoplastic polymer can thereafter be used as a film for later application to a textile or other material.

The activated region, or regions, of the textile may take on any appropriate form depending upon the specific structural requirements of the finished textile. For example, one or more edge portions of the textile may be activated to provide a stiffer edge portion for attaching the textile to another element without reducing the elasticity of the center of the textile. Alternatively, or in addition, activated regions may take the form of a plurality of elongate elements (e.g., thin bars of consistent or varying thickness) that extend in parallel, or substantially parallel, in a first direction to reduce the elasticity of the textile in the first direction without substantially reducing the elasticity of the textile in a second, perpendicular, direction. The direction and thickness of these elongate elements may remain constant or may change along their length to provide varying degrees and directions of elasticity in different regions of the textile. The elongate elements may also radiate out from a region (rather than extend in parallel), cross over each other, and/or be arranged in any other appropriate manner depending upon the specific structural qualities required.

In certain embodiments, the activated regions may include, or consist essentially of, one or more islands of material within the textile, with the location and shape of those islands correlating to localized regions of the textile requiring modified structural properties. Those islands may be within the central region of the textile and/or abut an edge portion of the textile and can be of any appropriate size and/or shape. In one embodiment both the geometry (e.g., the size, shape, and/or orientation) of the activated regions and the degree of activation of those regions (through either variations in the polymer applied to these regions and/or the amount of activation applied) can be used to form finished textile components having a wide variety of structural performance characteristics spaced throughout.

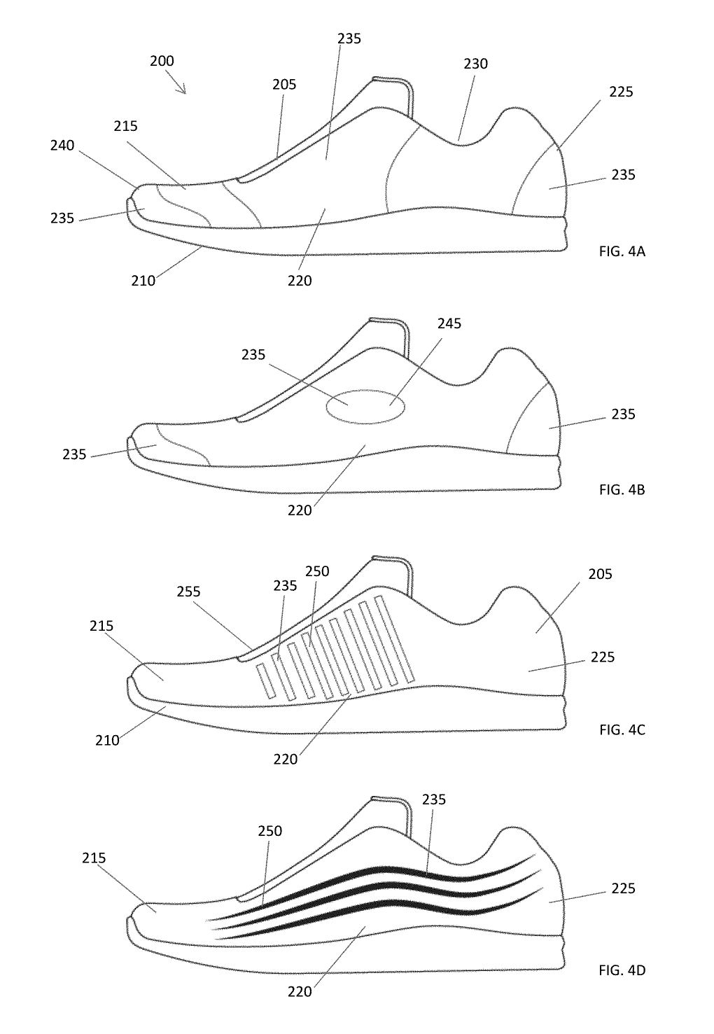

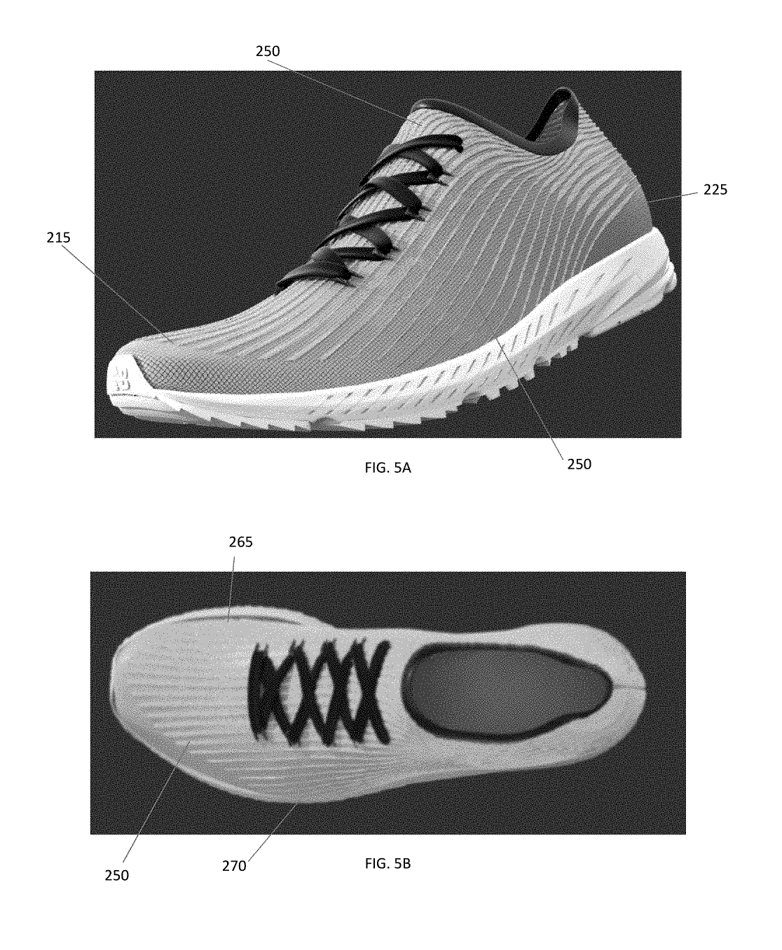

One aspect of the invention described herein allows for the creation of uppers for articles of footwear (e.g., shoes, boots, flip-flops, sandals, socks, athletic supports such as compression support elements, etc.), and/or elements for incorporation into an upper for an article of footwear, that provide superior performance and/or decorative features (including customized, personalized, and individualized features) without adding significant cost or complexity to the article and its manufacture. Exemplary shoes featuring treated textiles as described herein are shown in FIGS. 4A to 5B.

FIG. 4A shows a shoe 200 having an upper 205 and a sole 210. The shoe has a forefoot region 215, a midfoot region 220, a heel region 225, and a foot opening 230. The shoe 200 of FIG. 4A includes regions of activated material 235 within the toe region 240, the midfoot or saddle region 220, and the heel region 225 to reduce the elasticity of the upper 205 in those regions and provide increased support and protection for the foot of a wearer in those regions.

FIG. 4B shows a shoe having an island 245 of activated material 235 in a midfoot region 220 which can be used to provide structural support in that region and/or aesthetic indicia in that region of the shoe 200. FIG. 4C shows a shoe 200 having a plurality of elongate elements 250 of activated material 235 extending throughout the midfoot region 220 from a lacing region 255 of the upper 205 to the sole 210 to reduce the elasticity in that region in the direction running from the lacing region 255 to the sole 210 without substantially reducing the elasticity on the longitudinal direction running from the forefoot region 215 to the heel region 225 of the shoe 200. FIG. 4D shows a shoe 200 having a plurality of regions of activated material 235 formed as elongate elements 250 of varying width and direction extending in a substantially longitudinal direction running from the forefoot region 215 to the heel region 225 of the shoe 200. Similarly, FIGS. 5A and 5B show another example of a shoe 200 having a plurality of regions of activated material 235 formed as elongate elements 250 of varying width and direction extending in a substantially longitudinal direction running from the forefoot region 215 to the heel region 225 of the shoe 200. In certain embodiments, the structural properties created on a medial side 265 of the shoe 200 can be the same as, similar to, or differ from the structural properties of the lateral side 270 of the shoe 200, depending upon the specific performance requirements of the shoe 200.

In one embodiment, the activated polymer region can comprise a single activated structural element (e.g., a single island 245 or elongate element 250), while, in an alternative embodiment, the activate polymer region can comprise a plurality of discrete activated structural elements that can be arranged in a regular and/or irregular pattern of discrete elements, and can, for example, form a repeated array of discrete elements forming a region of increased support and/or protection on at least a portion of the upper. The individual activated structural elements can include, or consist essentially of, a portion of at least one spheroid (e.g., a portion of at least one of an oblate, a prolate, or a spherical spheroid) and/or a portion of at least one polyhedron (e.g., a portion of at least one of a triangular, a square, a rectangular, a pentagonal, or a hexagonal polyhedron). In alternative embodiments, the activated structural elements can be formed of any regular or irregular shape, and the shape and orientation of the activated structural elements can remain constant or vary across a portion of the upper. In one embodiment, the size, shape, and orientation of the activated structural elements can be selected to provide directional support to a portion of the upper, with the size, shape, and orientation of the activated structural elements varying across the upper portion to provide differing degrees and directions of support to different regions of the upper portion. For example, larger activated structural elements and/or more closely distributed activated structural elements can be positioned in a first region of the material requiring more support and/or protection, while smaller activated structural elements and/or more spaced-apart activated structural elements can be positioned in a second region requiring less support and/or protection. The change in the size and distribution of these activated structural elements can be abrupt or gradual, depending on the specific requirements of the material.

In one embodiment, the activated structural elements can be formed as distinct, separate elements with areas of un-activated material therebetween. In an alternative embodiment, the activated structural elements can be formed as an interlocked grid or web of activated material with discrete regions of un-activated material therebetween. In a further embodiment the activated structural elements can comprise a combination of distinct, separate activated elements and interlocked grid or web of elements. This may, for example, include a region including an interlocked region of elements (e.g., where more support is required) and a region of non-connected elements (e.g., where less support is required). The size and shape of the interlocking elements extending between the activated structural elements can change depending on the structural requirements of the material with, for example, larger interconnecting elongate web elements extending between the activated structural elements in regions where more support/less stretch is required.

In one embodiment, the regions of activated material 235 can be aligned to, or substantially aligned to, directions of stress and strain exhibited by a shoe during a specific athletic activity, with those directions obtained, for example, through experimentation and observation. In one embodiment regions of activated material 235 can be arranged to create a specific aesthetic pattern on the shoe in addition to, or instead of, providing a specific performance benefit. In one embodiment, the activated material 235 can thereafter be used to provide a bonding element by which other materials or indicia can be attached to the shoe upper 205 (for example through heat pressing of another element to a region of activated material 235). In one embodiment, the polymer used to form the region(s) of activated material 235 can be selected to facilitate bonding of the upper 205 to the sole 210 during shoe 200 construction, with the region(s) of activated material 235 forming at least a portion of a lower edge of the upper 205 that is bonded to the sole 210 to form the finished shoe 200. In one embodiment, the addition of activated material 235 to certain portions of a textile can allow the textile to be formed and flexibly held in a desired shape.

In an alternative embodiment, the textiles created hereby can form an article of apparel, or a portion thereof, and, for example, an article of apparel for use in athletic activity. In this embodiment, the activated regions can be used to support certain regions of the body and/or certain muscle groups to provide support and protection for those portions of the body and/or to provide superior support for certain athletic activities or movements. For example, the activated regions can be used to provide controlled compression characteristics for the apparel or provide direction elasticity to support a specific form of athletic movement.

An exemplary embodiment of the invention relates to a textile coating, and a related method of applying the textile coating to a textile to create a textile element having different structural properties in different regions thereof. The textile coating preferably allows for the selective activation of one or more areas of a textile to alter mechanical properties including but not limited to flexibility, hardness, strength, permeability, breathability, or the like. In addition, certain embodiments of the invention allow for this selective activation without substantially altering the appearance of the textile upon application of the textile coating.

The coating can be made of polymer that can be selectively activated to change the mechanical properties by application of heat, light, a catalyst, etc. Preferably, the coating contains a formulation containing thermoplastic particles. One advantage of using thermoplastics is that even after application to the textile the thermoplastics can be melted and allowed to re-flow. Alternatively, the coating can contain thermoplastic copolyesters (e.g. Hytrels), thermoplastic styrene-butadiene rubbers, thermoplastic styrene acrylic copolymers, other thermoplastic rubbers, thermoplastic urethanes (TPUs), crosslinkable Elastomers (such as SBS, SIS, SBR, or Sartomer™ products), and/or Kraton™ products. Cross-linkable elastomer systems can be activated by several means, including but not limited to heat, light, electric current, etc.

Exemplary General Method of Treating Textile Element

### Create Mixture 1:

Mix surfactant and water
Optionally apply energy to help dissolve by, for example, heat, vortex, sonicator or high shear mixing

### Create Mixture 2:

Mix thermoplastic in solvent
Optionally apply energy to help dissolve by, for example, heat, vortex, sonicator or high shear mixing

### Combine Mixtures 1 and 2:

Apply high energy mixing to disperse by, for example, sonicator or high shear mixing
Evaporate the solvent added in mixture 2 from the combined mixture, leaving small thermoplastic particles coated with surfactant in water
   Coat textile with water and polymer mixture
   Selectively activate areas

Specific Exemplary Method 1

### Create Mixture 1:

Surfactant Sodium Dodecyl Sulfate (SDS) with HLB number of 40 is dissolved in water at a concentration of 0.05 g/mL.
Mixture is set on a stir plate and allowed to fully dissolve; 100 mL of aqueous surfactant solution is prepared.

### Create Mixture 2:

Thermoplastic copolyester Hytrel 4069 is dissolved in dichloromethane at a concentration of 0.15 g/m L.
Mixture is set on a stir plate and allowed to fully dissolve.

### Emulsification of Mixture:

Using an ultrasonic horn with 0.25″ tip and set at an amplitude of 20%, the aqueous surfactant solution is sonicated, causing shearing.
At a rate of 0.25 mL/s, polymer solution is added to the aqueous surfactant solution.
As the polymer solution is added, ultrasonication causes micro-droplets to form and separate
66 mL of polymer solution is added (totaling 10 g of total polymer).
After complete addition, sonication allowed to shear mixture for 5 minutes.

### Finishing Mixture:

Upon completion of sonication, mixture is set on a hotplate set at 40° C. and allowed to stir continuously.
Heating allows for driving off of excess solvent (DCM), forming solid-state micro-scale polymer beads in aqueous solution.
   Coating Textile with Mixture:
Using aqueous polymer solution, textile is saturated via dip-coating.
Based on desired level of polymer content, textile is then run through pressure controlled roller system.
Excess material is squeezed from textile back into holding reservoir, allowing for controlled deposition of polymer solution.

### Drying Coated Textile:

Upon dip and squeeze of the textile, textile is then heated at temperatures <150° C. to drive off water, leaving polymer on textile surface.

### Activation of Polymer in Select First Areas of Textile:

Textile coated may then be selectively activated by applying heat >200° C. with pressures >20 psi to melt and weld polymer particulates.
   Removal of Polymer from Unactivated Second Areas of Textile:
Unactivated areas may be removed by washing textile with aqueous solvent.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A method of treating a textile element for incorporation into at least a portion of an upper of an article of footwear, the method comprising the steps of:
applying a thermoplastic polymer to a textile element having at least one first region and at least one second region;
selectively activating the thermoplastic polymer in the at least one first region to modify at least one structural property of the at least one first region; and
leaving the thermoplastic polymer in the at least one second region of the textile element unactivated, wherein the at least one modified structural property of the at least one first region differs from at least one structural property of the at least one second region.

2. The method of claim 1, wherein the textile element comprises at least one of a knit material, a woven material, a non-woven material, a skrim, a polyester, a nylon, a spandex, a natural fiber, cotton, and wool.

3. The method of claim 1, wherein applying the thermoplastic polymer to the textile element comprises dipping the textile element in the thermoplastic polymer.

4. The method of claim 1, wherein applying the thermoplastic polymer to the textile element comprises coating the thermoplastic polymer onto the textile element through at least one of spray coating, rolling, and painting.

5. The method of claim 1, wherein applying the thermoplastic polymer to the textile element comprises controlling the extent to which the thermoplastic polymer penetrates into the textile element.

6. The method of claim 1, wherein applying the thermoplastic polymer to the textile element comprises:
providing a first solution comprising a continuous phase solution;
dispersing a discontinuous phase in the first solution to form a stabilized mixture, the discontinuous phase comprising the thermoplastic polymer;
applying the stabilized mixture to a textile element; and
treating the textile element to remove the continuous phase solution from the textile element while leaving the thermoplastic polymer in place on the textile element.

7. The method of claim 1, wherein selectively activating the thermoplastic polymer in the at least one first region comprises heat pressing the at least one first region.

8. The method of claim 1, wherein selectively activating the thermoplastic polymer in the at least one first region comprises exposing the at least one first region to at least one of heat, pressure, light, HF waves, UV waves, and a chemical reactant.

9. The method of claim 1, wherein selectively activating the thermoplastic polymer in the at least one first region comprises heat pressing the first region, and wherein the textile element is further heated in an oven to set the thermoplastic polymer in the second region without heat pressing.

10. The method of claim 1, further comprising removing the unactivated thermoplastic polymer in the at least one second region after selectively activating the thermoplastic polymer in the at least one first region.

11. The method of claim 10, wherein removing the unactivated thermoplastic polymer comprises washing the textile element in at least one aqueous solution.

12. The method of claim 1, wherein the at least one structural property of the first region and the second region comprises at least one of a modulus of elasticity, a stiffness, a flexibility, a hardness, a strength, a tear strength, a tensile strength, a permeability, a breathability, a bond strength, and an abrasion resistance of the textile element.

13. The method of claim 12, wherein the first region comprises a plurality of discrete elongate portions of the upper, and wherein activation of the thermoplastic polymer in the first region provides structural support to the upper.

14. The method of claim 12, wherein the first region comprises an array of separate, discrete islands of activated material.

15. The method of claim 12, wherein the first region comprises a web of interconnecting portions of activated material.

16. The method of claim 1, wherein the at least one thermoplastic polymer comprises at least one of thermoplastic polyurethane, thermoplastic copolyesters, thermoplastic styrene acrylic copolymers, thermoplastic rubbers, synthetic rubber, elastomeric copolymers, crosslinkable elastomers, polyester block copolymers, polyolefins, and engineered polyethelenes.

17. A method of forming an article of footwear, the method comprising the steps of:
providing an upper for an article of footwear, the upper comprising at least one textile element, wherein forming the at least one textile element comprises:
applying a thermoplastic polymer to the at least one textile element having at least one first region and at least one second region;
selectively activating the thermoplastic polymer in the at least one first region to modify at least one structural property of the at least one first region; and
leaving the thermoplastic polymer in at least one second region unactivated, wherein the at least one structural property of the at least one first region differs from at least one structural property of the at least one second region;
providing a sole element; and
attaching the sole element to the upper.

18. The method of claim 17, wherein forming the at least one textile element further comprises removing the unactivated thermoplastic polymer in the at least one second region after selectively activating the thermoplastic polymer in the at least one first region.

19. The method of claim 18, wherein removing the unactivated thermoplastic polymer comprises washing the textile element in at least one aqueous solution.

20. The method of claim 17, wherein the at least one first region comprises at least one of an array of separate, discrete islands of activated material, a plurality of discrete elongate elements of activated material, and an interconnected web of activated material.
